(19) United States
(12) Patent Application Publication
(10) Pub. No.: US 2026/0128223 A1
(43) Pub. Date: May 7, 2026

(54) MULTILAYER CERAMIC CAPACITOR

(71) Applicant: Murata Manufacturing Co., Ltd., Nagaokakyo-shi (JP)

(72) Inventors: Kazuya TAGA, Nagaokakyo-shi (JP); Yosuke TERASHITA, Nagaokakyo-shi (JP); Takuya SASAKURA, Nagaokakyo-shi (JP)

(21) Appl. No.: 19/436,379

(22) Filed: Dec. 30, 2025

Related U.S. Application Data
(63) Continuation of application No. PCT/JP2024/021452, filed on Jun. 13, 2024.

(30) Foreign Application Priority Data
Jul. 3, 2023 (JP) 2023-109180

(51) Int. Cl. H01G 4/232; H01G 4/30

(52) U.S. Cl. CPC H01G 4/2325; H01G 4/30

(57) ABSTRACT

A multilayer ceramic capacitor includes an outer electrode and a multilayer body including a plurality of dielectric layers and a plurality of inner electrode layers that are stacked on top of each other. The outer electrode includes a plating layer and a base electrode layer. The base electrode layer includes glass. The glass includes an alkaline-earth metal. In a thickness direction of the base electrode layer, when a mass ratio of the alkaline-earth metal in the glass present in a central portion is 100, a mass ratio of the alkaline-earth metal in the glass present in a near-surface portion adjacent to the plating layer is 90 or more and less than 100.

### CROSS REFERENCE TO RELATED APPLICATIONS

This application claims the benefit of priority to Japanese Patent Application No. 2023-109180 filed on Jul. 3, 2023 and is a Continuation Application of PCT Application No. PCT/JP2024/021452 filed on Jun. 13, 2024. The entire contents of each application are hereby incorporated herein by reference.

### BACKGROUND OF THE INVENTION

### 1. Field of the Invention

The present disclosure relates to multilayer ceramic capacitors.

### 2. Description of the Related Art

As described in Japanese Unexamined Patent Application Publication No. 2021-019018, an outer electrode of a multilayer ceramic capacitor generally includes a base electrode layer formed on a surface of a multilayer body such as a ceramic body, and a plating layer provided on the base electrode layer. For the purpose of densification, the base electrode layer is often formed from a conductive paste including glass. The glass used for the base electrode layer is designed so as to satisfy various demand characteristics, such as filling pores inside the outer electrode to form a dense film, acting as an aid in the sintering process, adhering to the body after baking, and the glass itself having chemical durability.

### SUMMARY OF THE INVENTION

In a multilayer ceramic capacitor, when a base electrode layer of an outer electrode includes glass, solder popping tends to occur. Solder popping is a phenomenon in which, for example, when the multilayer ceramic capacitor is mounted on a circuit board and fixed by soldering, moisture and a plating solution that have entered the base electrode layer rapidly evaporate due to the heat of soldering, and the outside solder spatters, which may cause a short-circuit failure.

Example embodiments of the present invention provide multilayer ceramic capacitors each including an outer electrode that is less likely to cause solder popping.

A multilayer ceramic capacitor according to an example embodiment of the present disclosure includes an outer electrode and a multilayer body including a plurality of dielectric layers and a plurality of inner electrode layers that are stacked on top of each other. The outer electrode includes a plating layer and a base electrode layer. The base electrode layer includes glass. The glass includes an alkaline-earth metal. In a thickness direction of the base electrode layer, when a mass ratio of the alkaline-earth metal in the glass present in a central portion is 100, a mass ratio of the alkaline-earth metal in the glass present in a near-surface portion adjacent to the plating layer is 90 or more and less than 100.

According to example embodiments of the present disclosure, multilayer ceramic capacitors each including an outer electrode that is less likely to cause solder popping are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating the appearance of a multilayer ceramic capacitor according to an example embodiment of the present disclosure.

FIG. 2 is a sectional view of the multilayer ceramic capacitor in FIG. 1 taken along line II-II.

FIG. 3 is a sectional view of the multilayer ceramic capacitor in FIG. 1 taken along line III-III.

FIG. 4 is a sectional view illustrating a layer configuration of an outer electrode.

FIG. 5 is a schematic view for explaining the microstructure of a base electrode layer.

FIG. 6 is a sectional view for explaining a central portion, a near-surface portion, and a near-interface portion of the base electrode layer.

### DETAILED DESCRIPTION OF THE EXAMPLE EMBODIMENTS

Hereinafter, multilayer ceramic capacitor according to example embodiments of the present disclosure will be described with reference to figures. In the following description of example embodiments, like or corresponding elements, structures, or features in the figures are denoted by like reference numerals and will not be repeatedly described.

The multilayer ceramic capacitor includes an outer electrode and a multilayer body including a plurality of dielectric layers and a plurality of inner electrode layers that are stacked on top of each other. The outer electrode is positioned such that the base electrode layer side is located on the multilayer body.

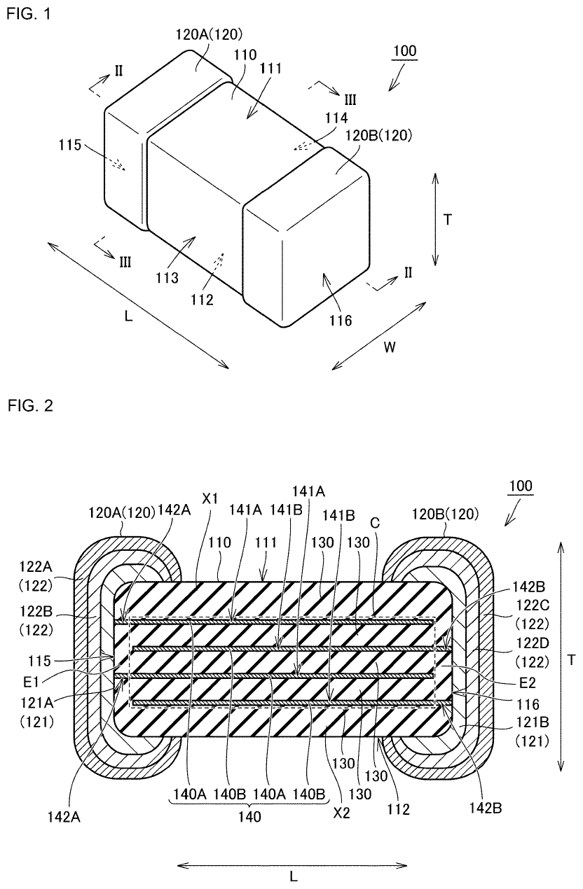

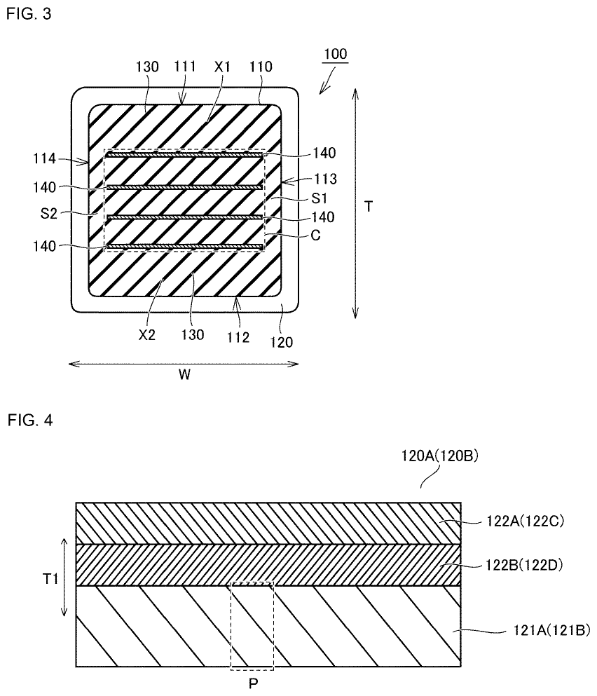

FIG. 1 is a perspective view illustrating the appearance of a multilayer ceramic capacitor according to an example embodiment of the present disclosure. FIG. 2 is a sectional view of the multilayer ceramic capacitor in FIG. 1 taken along line II-II. FIG. 3 is a sectional view of the multilayer ceramic capacitor in FIG. 1 taken along line III-III.

As illustrated in FIGS. 1 to 3, a multilayer ceramic capacitor 100 according to an example embodiment of the present disclosure includes a multilayer body 110 and an outer electrode 120. As illustrated in FIGS. 2 and 3, the multilayer body 110 includes a plurality of dielectric layers 130 and a plurality of inner electrode layers 140 that are stacked one by one in an alternating manner along a stacking direction T. The multilayer body 110 includes a first main surface 111 and a second main surface 112 that are opposed to each other in the stacking direction, a first side surface 113 and a second side surface 114 that are opposed to each other in a width direction perpendicular to the stacking direction, and a first end surface 115 and a second end surface 116 that are opposed to each other in a length direction perpendicular to the stacking direction and the width direction. The multilayer body 110 is divided into an inner layer portion C, a first outer layer portion X1, a second outer layer portion X2, a first side margin portion S1, a second side margin portion S2, a first end margin portion E1, and a second end margin portion E2.

As illustrated in FIGS. 1 to 3, the outer electrode 120 is located on a surface of the multilayer body 110. As illustrated in FIG. 2, the outer electrode 120 includes a base electrode layer 121 and a plating layer 122. The outer electrode 120 may include a first outer electrode 120A and a second outer electrode 120B. The first outer electrode 120A is provided on and around the first end surface 115. The second outer electrode 120B is provided on and around the second end surface 116.

The first outer electrode 120A is provided on the first end surface 115 of the multilayer body 110 so as to be electrically connected to first inner electrode layers 140A, and extends from the first end surface 115 to the first main surface 111 and the second main surface 112 and to the first side surface and the second side surface. The second outer electrode 120B is provided on the second end surface 116 of the multilayer body 110 so as to be electrically connected to second inner electrode layers 140B, and extends from the second end surface 116 to the first main surface 111 and the second main surface 112 and to the first side surface and the second side surface.

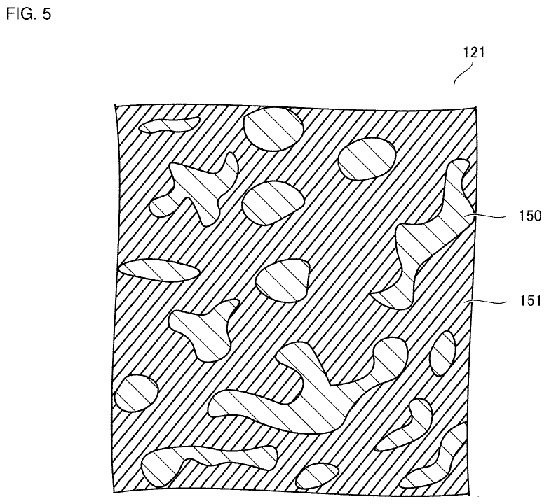

As illustrated in FIG. 4, the first outer electrode 120A (the second outer electrode 120B) includes a first base electrode layer 121A (a second base electrode layer 121B), a first lower plating layer 122B (a second lower plating layer 122D) provided on the first base electrode layer 121A (the second base electrode layer 121B), and a first upper plating layer 122A (a second upper plating layer 122C) provided on the first lower plating layer 122B (the second lower plating layer 122D).

FIG. 5 is a schematic view for explaining the microstructure of the base electrode layer 121. As illustrated in FIG. 5, the base electrode layer 121 includes glass 150. The base electrode layer can be a sintered body layer of a conductive paste including a glass composition. The conductive paste will be described later.

The glass 150 may include, for example, borosilicate glass. Borosilicate glass is glass including boron oxide (B2O3) and silicon oxide (SiO2) as network-forming oxides.

The glass 150 includes an alkaline-earth metal. The alkaline-earth metal can include, for example, at least one element selected from the group consisting of calcium (Ca), strontium (Sr), and barium (Ba). The alkaline-earth metal may further include magnesium (Mg). The alkaline-earth metal can be included in the glass 150 in the form of a network-modifying oxide (e.g., Cao, SrO, Bao, or MgO).

In a thickness direction (an arrow Tl direction in FIG. 4) of the base electrode layer 121, when a mass ratio (hereinafter also referred to as a first ratio) of the alkaline-earth metal in the glass present in a central portion is 100, a mass ratio (hereinafter also referred to as a second ratio) of the alkaline-earth metal in the glass present in a near-surface portion adjacent to the plating layer is 90 or more and less than 100, for example. When the second ratio is in this range, solder popping tends to be easily reduced or prevented. The mass ratio of the alkaline-earth metal in the glass is the ratio of the mass of the alkaline-earth metal included in the glass based on the mass of the glass. The mass ratio of the alkaline-earth metal in the glass is determined according to a method that will be described in the section of EXAMPLES described later.

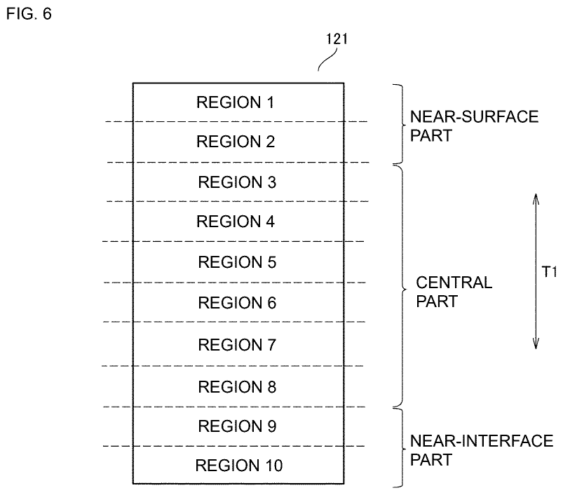

The central portion and the near-surface portion will be described with reference to FIG. 6. FIG. 6 is an enlarged sectional view of a region P outlined by a dashed line in the base electrode layer illustrated in FIG. 4. As illustrated in FIG. 6, when the base electrode layer 121 is divided in the thickness direction into 10 equal regions, which are named regions 1, 2, . . . , and 10 in order from the plating layer side, the regions 1 and 2 are referred to as the near-surface portion, and the regions 3 to 8 are referred to as the central portion.

As a result of analyzing an outer electrode of a multilayer ceramic capacitor, it was discovered that in a base electrode layer, the mass ratio of an alkaline-earth metal in glass present near a surface layer tended to be lower than the mass ratio of the alkaline-earth metal in the glass present in a central portion. This is presumably because in a plating step of forming a plating layer, upon contact of the base electrode layer with water and a plating solution, the alkaline-earth metal in the glass leached out into the plating solution, and along with this, other components also transferred, thus resulting in a change in the composition of the glass. This can result in a decrease in the mass ratio of the alkaline-earth metal in the glass present near the surface layer, erosion of the glass, an increased likelihood that moisture and the plating solution enter the base electrode layer, and hence an increased likelihood of solder popping. The multilayer ceramic capacitor according to an example embodiment of the present disclosure is less likely to cause solder popping because in the thickness direction of the base electrode layer, the difference between the contents of the alkaline-earth metal in the glass present in the central portion and the near-surface portion adjacent to the plating layer is small. The likelihood of solder popping is evaluated according to a method that will be described in the section of EXAMPLES described later.

When the first ratio is 100, the second ratio is preferably 96 or more, for example, from the viewpoint of reduction or prevention of solder popping. The second ratio may be, for example, 98 or less.

In the base electrode layer 121, when the mass ratio of the alkaline-earth metal in the glass present in the region 6 is 100, the mass ratio of the alkaline-earth metal in the glass present in the region 1 is preferably 90 or more and less than 100, for example, from the viewpoint of reduction or prevention of solder popping.

In the thickness direction of the base electrode layer 121, when the first ratio is 100, a mass ratio (hereinafter also referred to as a third ratio) of the alkaline-earth metal in the glass present in a near-surface portion adjacent to the multilayer body 110 (hereinafter also referred to as a near-interface portion) can be 105 or more and 115 or less, for example. When the third ratio is in this range, a decrease in multilayer body strength described below tends to be easily reduced or prevented. The near-interface portion corresponds to the regions 9 and 10 mentioned above.

As a result of analyzing an outer electrode of a multilayer ceramic capacitor, it was discovered that in a base electrode layer, the mass ratio of an alkaline-earth metal in glass present near the interface with a multilayer body tended to be higher than the mass ratio of the alkaline-earth metal in the glass present in a central portion. The higher mass ratio of the alkaline-earth metal in the glass present near the interface with the multilayer body is presumably because the alkaline-earth metal included in the multilayer body tends to diffuse into the base electrode layer. Therefore, it is considered that an outer electrode in which the difference between the contents of an alkaline-earth metal in glass present in a central portion and a near-interface portion in the thickness direction of a base electrode layer is small tends to easily reduce or prevent a decrease in multilayer body strength. The multilayer body strength is evaluated according to a method that will be described in the section of EXAMPLES described later.

When the first ratio is 100, the third ratio is preferably 112 or less from the viewpoint of reduction or prevention of a decrease in multilayer body strength.

The glass 150 can further include an alkali metal. The alkali metal can be, for example, at least one element selected from lithium (Li), sodium (Na), and potassium (K). The alkali metal can be included in the glass 150 in the form of a network-modifying oxide (e.g., Li₂O, Na₂O, or K₂O).

The glass 150 may include oxides other than the above, for example, oxides such as transition metal oxides, zinc oxide (ZnO), aluminum oxide (Al2O3), and bismuth oxide (Bi2O3).

The glass 150 may further include a metal oxide such as copper oxide (CuO), for example.

The base electrode layer 121 can further include at least one conductive component selected from the group consisting of copper (Cu), nickel (Ni), and a Cu—Ni alloy. The conductive component may be conductive powder. The conductive component can be included in a region (hereinafter also referred to as a conductive region) 151 other than the glass 150.

When the base electrode layer 121 includes a conductive paste described later, the conductive region 151 may include a metal sintered body resulting from sintering of the conductive powder included in the conductive paste.

The thickness of the base electrode layer 121 may be, for example, 10 μm or more and 50 μm or less, preferably 15 μm or more and 40 μm or less. The thickness of the base electrode layer 121 is measured as follows. First, the multilayer ceramic capacitor 100 is polished to expose a section perpendicular to the width direction W. The exposed section is observed under a microscope to make a measurement. The measurement position is the central portion in the stacking direction T.

The base electrode layer 121, at or near its end portions on the first main surface 111, the second main surface 112, the first side surface 113, and the second side surface 114, tends to have a small thickness and is likely to be affected by a plating solution. Since the contents of the alkaline-earth metal in the glass included in the base electrode layer 121 are at the first ratio and the second ratio described above, solder popping can be reduced or prevented also at or near the end portions where the thickness tends to be small.

The plating layer 122 can include, for example, nickel (Ni), Cu, silver (Ag), gold (Au), tin (Sn), or an alloy including any of these metals. The plating layer 122 may include a plurality of layers including different components. The plating layer 122 may have a two-layer structure including an upper plating layer (the first upper plating layer 122A and the second upper plating layer 122C may be collectively referred to as the upper plating layer) and a lower plating layer (the first lower plating layer 122B and the second lower plating layer 122D may be collectively referred to as the upper plating layer). Each lower plating layer is provided on the base electrode layer and can prevent the base electrode layer from being eroded by solder when the multilayer ceramic capacitor is mounted. The lower plating layer may be, for example, a Ni plating layer. The upper plating layer is provided on the lower plating layer. The upper plating layer may be, for example, a Sn plating layer. The Sn plating layer has good wettability with Sn-including solder, and thus enables the multilayer ceramic capacitor to be mounted with improved mountability.

The upper plating layer and the lower plating layer may have a thickness of, for example, 0.5 μm or more and 10 μm or less, preferably 5.5 μm or less, more preferably 4.5 μm or less.

The thickness of each of the upper plating layer and the lower plating layer is measured as follows. First, the multilayer ceramic capacitor 100 is polished with a FIB device to expose a section perpendicular to the width direction W. The exposed section is observed under a microscope to measure the thickness of each of the plating layers. The measurement position is the central portion in the stacking direction T. The thickness of the upper plating layer may be measured using an X-ray fluorescence thickness meter.

The dielectric layers 130 include a plurality of crystal grains including, for example, a BaTiO3-based perovskite-type compound. One example of such a dielectric material is a BaTiO3-based perovskite-type compound in which some of Ba2+ in the crystal lattice are substituted with Re3+, rare-earth element ions. Examples of the BaTiO3-based perovskite-type compound include BaTiO3 and compounds derived by substituting at least one of Ba2+ and Ti⁴⁺ of BaTiO₃ with other ions such as Ca2+ and Zr4+.

The thickness of each of the plurality of dielectric layers 130 included in the inner layer portion C is preferably 0.4 μm or more and 0.8 μm or less, more preferably 0.5 μm or more and 0.7 μm or less, for example. In this specification, the thickness of each layer is the thickness at the middle of an end surface.

The plurality of inner electrode layers 140 include a plurality of first inner electrode layers 140A connected to the first outer electrode 120A and a plurality of second inner electrode layers 140B connected to the second outer electrode 120B.

As illustrated in FIG. 2, the first inner electrode layers 140A include opposing electrode portions 141A opposed to the second inner electrode layers 140B with the dielectric layers 130 interposed therebetween and extended electrode portions 142A extending from the opposing electrode portions 141A to the first end surface 115 of the multilayer body 110. The second inner electrode layers 140B include opposing electrode portions 141B opposed to the first inner electrode layers 140A with the dielectric layers 130 interposed therebetween and extended electrode portions 142B extending from the opposing electrode portions 141B to the second end surface 116 of the multilayer body 110.

The first inner electrode layers 140A and the second inner electrode layers 140B opposed to each other with the dielectric layers 130 interposed therebetween constitute one capacitor. The multilayer ceramic capacitor 100 is, in other words, a plurality of capacitors connected in parallel through the first outer electrode 120A and the second outer electrode 120B.

As a conductive material of the inner electrode layers 140, at least one metal selected from Ni, Cu, Ag, palladium (Pd), and the like or an alloy including any of these metals can be used. The inner electrode layers 140 may further include dielectric particles called an auxiliary material.

The thickness of each of the plurality of inner electrode layers 140 is preferably 0.3 μm or more and 1.0 μm or less, for example. The coverage at which each of the plurality of inner electrode layers 140 covers the dielectric layers 130 without a gap is preferably 50% or more and 95% or less, for example.

The thickness of each of the dielectric layer 130 and the inner electrode layer 140 included in the inner layer portion C is measured as follows. First, the multilayer ceramic capacitor 100 is polished to expose a section perpendicular to the length direction L. The exposed section is observed under a scanning electron microscope. Next, a center line passing through the center of the exposed section and extending along the stacking direction T is drawn, and two lines are drawn at equal intervals on each side of the center line. The thickness of each of the dielectric layer 130 and the inner electrode layer 140 on the total of five lines is measured. The average of the five measured values of the dielectric layer 130 is determined as the thickness of the dielectric layer 130. The average of the five measured values of the inner electrode layer 140 is determined as the thickness of the inner electrode layer 140.

Alternatively, the following method may be used: in each of an upper portion, a central portion, and a lower portion located on boundary lines that divide the exposed section into four equal parts in the stacking direction T, the thickness of each of the dielectric layer 130 and the inner electrode layer 140 on the above five lines is measured, and the average of the measured values of the dielectric layer 130 is determined as the thickness of the dielectric layer 130, and the average of the measured values of the inner electrode layer 140 is determined as the thickness of the inner electrode layer 140.

The first outer layer portion X1 and the second outer layer portion X2 are provided, in the multilayer body 110, between the first main surface 111 and the inner electrode layer 140 closest to the first main surface 111 and between the second main surface 112 and the inner electrode layer 140 closest to the second main surface 112, respectively. The inner layer portion C is provided in a region flanked by these two first outer layer portion X1 and second outer layer portion X2.

The inner layer portion C generates an electrostatic capacitance due to its structure in which the opposing electrode portions 141A of the first inner electrode layers 140A and the opposing electrode portions 141B of the second inner electrode layers 140B are stacked in the stacking direction T. The first outer layer portion X1 is located on the first main surface 111 side of the inner layer portion C in the stacking direction T. The second outer layer portion X2 is located on the second main surface 112 side of the inner layer portion C in the stacking direction T.

The first side margin portion S1 is located on the first side surface 113 side of the inner layer portion C in the width direction W. The second side margin portion S2 is located on the second side surface 114 side of the inner layer portion C in the width direction W. The first end margin portion E1 is located on the first end surface 115 side of the inner layer portion C in the length direction L. The second end margin portion E2 is located on the second end surface 116 side of the inner layer portion C in the length direction L.

From the viewpoint of reducing the size of the multilayer ceramic capacitor 100, the dimension of the first side margin portion S1 in the width direction W, the dimension of the second side margin portion S2 in the width direction W, the dimension of the first end margin portion E1 in the length direction L, and the dimension of the second end margin portion E2 in the length direction L are each preferably as small as possible without causing a decrease in the insulation resistance of the multilayer ceramic capacitor 100.

The multilayer ceramic capacitor 100 has a dimension in the length direction L of 2.0 mm or less, a dimension in the width direction W of 1.25 mm or less, and a dimension in the stacking direction T of 1.25 mm or less, for example. The external dimensions of the multilayer ceramic capacitor 100 can be measured by observing the multilayer ceramic capacitor 100 under a light microscope.

When the multilayer ceramic capacitor 100 is produced, a ceramic slurry is first prepared. Specifically, ceramic powder, a binder, a solvent, etc. are mixed at a predetermined blending ratio, whereby a ceramic slurry is formed.

Next, a ceramic green sheet is formed. Specifically, the ceramic slurry is formed into a sheet on a carrier film using a die coater, a gravure coater, a micro-gravure coater, or the like, whereby a ceramic green sheet is formed.

Next, a mother sheet is formed. Specifically, a conductive paste is printed on the ceramic green sheet so as to have a predetermined pattern by, for example, screen printing or gravure printing, whereby a mother sheet in which the predetermined conductive pattern is provided on the ceramic green sheet is formed.

In addition to the mother sheet having the conductive pattern, a ceramic green sheet on which no conductive pattern is formed is also prepared as a mother sheet.

Next, the mother sheets are stacked on top of each other. Specifically, a predetermined number of mother sheets which will constitute the first outer layer portion X1 and on which no conductive pattern is formed are stacked on top of each other, on which a plurality of mother sheets which will constitute the inner layer portion C and on which the conductive pattern is formed are sequentially stacked, on which a predetermined number of mother sheets which will define the second outer layer portion X2 and on which no conductive pattern is formed are stacked, whereby a group of mother sheets is formed.

Next, the group of mother sheets is pressure-bonded.

The group of mother sheets is pressed along the stacking direction to be bonded together by isostatic pressing or rigid pressing, whereby a mother multilayer body is formed.

Next, the mother multilayer body is divided.

Specifically, using a press-cutter or a dicing machine, the mother multilayer body is divided in matrix form and formed into pieces as a plurality of unfired multilayer bodies.

Next, the unfired multilayer bodies are subjected to barrel polishing. Specifically, the unfired multilayer bodies are enclosed in a small box called a barrel together with media balls harder than ceramic materials, and the barrel is rotated, whereby the corners and ridges of the unfired multilayer bodies are rounded into a curved shape.

Next, the unfired multilayer bodies are fired.

Specifically, the unfired multilayer bodies are heated to a predetermined temperature, whereby the dielectric ceramic material is fired. The firing temperature is appropriately set according to the type of the dielectric ceramic material, for example, in the range of 900° C. or higher and 1300° C. or lower.

Next, a base electrode layer is provided on a surface of each multilayer body. Specifically, the base electrode layer 121 is formed by, for example, a thin film forming method, a printing method, or a dipping method. For example, when the base electrode layer is formed by the dipping method, a conductive paste is applied to a first end surface and a second end surface of the multilayer body and then dried, and the conductive paste is baked. The baking temperature is set in the range of, for example, 700° C. or higher and 800° C. or lower. The base electrode layer can be a sintered body layer of the conductive paste.

The conductive paste can include a glass composition, a conductive component, and an organic component. The glass composition may be in the form of powder. The organic component includes, for example, a vehicle and an additive. The vehicle includes, for example, a resin and an organic solvent. The additive includes, for example, a dispersant and a rheology control agent. Appropriate materials can be selected from materials commonly used as organic materials for conductive pastes.

The glass composition included in the conductive paste, when its composition is expressed in mass ratio, may include Li₂O in the range of 0 to 2 mass %, Na₂O in the range of 0 to 8 mass %, CaO in the range of 1 to 8 mass %, SrO in the range of 0 to 8 mass %, BaO in the range of 20 to 60 mass %, B2O3 in the range of 16 to 28 mass %, SiO₂ in the range of 5 to 12 mass %, Al₂O₃ in the range of 12 to 20 mass %, TiO₂ in the range of 0 to 4.0 mass %, and CuO in the range of 0 to 5.0 mass %, with the total being 100 mass %, for example.

From the viewpoint of reduction or prevention of solder popping, preferably, the glass composition included in the conductive paste, when its composition is expressed in mass ratio, may include Li₂O in the range of 0 to 2 mass %, Na₂O in the range of 0 to 8 mass %, Cao in the range of 1 to 8 mass %, SrO in the range of 0 to 8 mass %, BaO in the range of 20 to 50 mass %, B2O3 in the range of 19 to 28 mass %, SiO₂ in the range of 5 to 12 mass %, Al₂O₃ in the range of 12 to 20 mass %, TiO₂ in the range of 2.5 to 4.0 mass %, and CuO in the range of 0 to 5.0 mass %, with the total being 100 mass %, for example.

When the glass composition included in the conductive paste includes Li₂O, Na₂O, Cao, Bao, and B2O3, the mass ratio (also referred to as the B ratio) of the total of Li₂O, Na₂O, Cao, and BaO to B2O3 is preferably 1.17 to 2.61, for example, from the viewpoint of reduction or prevention of solder popping and a decrease in multilayer body strength.

Next, a plating treatment is performed, so that a lower plating layer and an upper plating layer are sequentially formed by electrolytic plating so as to cover the base electrode layer. The plating layers may be formed by electrolytic plating using a barrel electroplating apparatus. Before the plating treatment, the base electrode layer may be subjected to a surface treatment such as sandblasting or water-repellent treatment. By forming the above electrodes, an outer electrode is formed.

Through the above series of steps, the multilayer ceramic capacitor 100 according to an example embodiment of the present disclosure is produced.

### EXAMPLES

The present disclosure will now be described in more detail with reference to Examples. In the examples, “%” and “parts” are mass % and parts by mass unless otherwise specified.

Sections of outer electrodes of multilayer ceramic capacitors fabricated in Examples and Comparative Examples were observed under a high-resolution transmission electron microscope (HRTEM). For each glass present in a near-surface portion, a central portion, and a near-interface portion of a base electrode layer, energy-dispersive X-ray analysis (EDX) attached to the HRTEM was performed at 10 points, and the average of mass ratios of an alkaline-earth metal in the glass in the near-surface portion and the near-interface portion relative to that in the central portion was determined.

For each of the multilayer ceramic capacitors fabricated in Examples and Comparative Examples, 35 samples were prepared. The ceramic capacitors prepared were heated to a temperature of 300° C. This heat treatment was performed twice. The outer electrode of each multilayer ceramic capacitor was observed using a light microscope, and the number of samples that underwent solder popping was counted. The evaluation results shown in Table 1 are based on the following evaluation criteria. 0: A1 and 2: B3 or more: C.

For each of the multilayer ceramic capacitors fabricated in Examples and Comparative Examples, 35 samples were prepared. In accordance with the test method for printed circuit board bending resistance in JIS C 60068-2-21, the multilayer ceramic capacitors prepared were each deflected by 1.5 mm, and the number of samples that underwent cracking after the test was counted. The evaluation results shown in Table 1 are based on the following evaluation criteria.0: G1 or more: NG

A glass composition having a composition shown in Table 1 and an organic component were mixed together to prepare a conductive paste. The conductive paste prepared was applied to a first end surface and a second end surface of a multilayer body including a plurality of dielectric layers and a plurality of inner electrode layers that are stacked on top of each other, dried, and then baked. After a surface of an outer electrode was subjected to a polish treatment (sandblasting or water-repellent treatment), a Ni plating layer was formed, and a Sn plating layer was further formed to fabricate a multilayer ceramic capacitor. The results are shown in Table 1.

TABLE 1

| | | | Second | Third | Evaluation | |
|---|---|---|---|---|---|---|
| | | | ratio/ | ratio/ | results of | Multilayer |
| | Composition of | B | first | first | solder | body |
| | glass composition | ratio | ratio | ratio | popping | strength |
| Example | Composition 1 | 3.67 | 90 | 115 | B | G |
| 1 | (not including | | | | | |
| | Li₂O, Na₂O, CuO) | | | | | |
| Example | Composition 2 | 1.17 | 96 | 112 | A | G |
| 2 | (including Li₂O, | | | | | |
| | Na₂O, CuO) | | | | | |
| Example | Composition 2 | 1.71 | 95 | 112 | B | G |
| 3 | (including Li₂O, | | | | | |
| | Na₂O, CuO) | | | | | |
| Example | Composition 2 | 2.35 | 94 | 110 | B | G |
| 4 | (not including | | | | | |
| | Li₂O, Na₂O, CuO) | | | | | |
| Example | Composition 2 | 2.61 | 98 | 108 | A | G |
| 5 | (not including | | | | | |
| | Li₂O, Na₂O) | | | | | |
| Example | Composition 2 | 2.75 | 98 | 105 | A | G |
| 6 | (not including | | | | | |
| | Li₂O, Na₂O) | | | | | |
| Comparative | Composition 1, | 3.57 | 80 | 128 | C | NG |
| Example | not including | | | | | |
| 1 | Li₂O, Na₂O, TiO₂, | | | | | |
| | Cuo, including | | | | | |
| | Zno, not | | | | | |
| | satisfying the | | | | | |
| | range of Al₂O₃ | | | | | |
| Comparative | Composition 1, | 3.00 | 87 | 116 | C | NG |
| Example | not including | | | | | |
| 2 | Na₂O, Zno, not | | | | | |
| | satisfying the | | | | | |
| | ranges of Al₂O₃ | | | | | |
| | and CuO | | | | | |

In the table, Composition 1 and Composition 2 have the following compositions.

### Composition 1

Li₂O in the range of 0 to 2 mass, Na₂O in the range of 0 to 8 mass %, CaO in the range of 1 to 8 mass %, SrO in the range of 0 to 8 mass %, Bao in the range of 20 to 60 mass %, B2O3 in the range of 16 to 28 mass %, SiO₂ in the range of 5 to 12 mass %, Al₂O₃ in the range of 12 to 20 mass %, TiO₂ in the range of 2.5 to 4.0 mass %, and CuO in the range of 0 to 5.0 mass % are included, with the total being 100 mass %.

### Composition 2

Li₂O in the range of 0 to 2 mass %, Na₂O in the range of 0 to 8 mass %, Cao in the range of 1 to 8 mass %, SrO in the range of 0 to 8 mass %, BaO in the range of 20 to 50 mass %, B2O₃ in the range of 19 to 28 mass %, SiO₂ in the range of 5 to 12 mass %, Al₂O₃ in the range of 12 to 20 mass %, TiO₂ in the range of 2.5 to 4.0 mass %, and CuO in the range of 0 to 5.0 mass % are included, with the total being 100 mass %.

As shown in Table 1, in Examples 1 to 6 according to an example embodiment of the present disclosure, the evaluation results of solder popping were better than in Comparative Examples 1 and 2. It can be seen that an outer electrode less likely to cause solder popping is provided according to an example embodiment of the present disclosure. In Examples 1 to 6, no decrease in multilayer body strength was observed as compared with Comparative Examples 1 and 2.

In the above description of the example embodiments, combinable configurations may be combined with each other.

The example embodiments disclosed herein are illustrative in all respects and should not be construed as limiting. The scope of the present invention is defined not by the foregoing description but by the claims, and is intended to include meanings equivalent to the claims and all modifications within the scope.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
an outer electrode; and
a multilayer body including a plurality of dielectric layers and a plurality of inner electrode layers that are stacked on top of each other; wherein
the outer electrode includes a plating layer and a base electrode layer;
the base electrode layer includes glass,
the glass includes an alkaline-earth metal; and
in a thickness direction of the base electrode layer, when a mass ratio of the alkaline-earth metal in the glass present in a central portion is 100, a mass ratio of the alkaline-earth metal in the glass present in a near-surface portion adjacent to the plating layer is 90 or more and less than 100.

2. The multilayer ceramic capacitor according to claim 1, wherein in the base electrode layer, the mass ratio of the alkaline-earth metal in the glass present in the near-surface portion adjacent to the plating layer is 96 or more and 98 or less.

3. The multilayer ceramic capacitor according to claim 1, wherein the glass includes borosilicate glass.

4. The multilayer ceramic capacitor according to claim 3, wherein the glass further includes an alkali metal.

5. The multilayer ceramic capacitor according to claim 3, wherein the glass further includes copper oxide.

6. The multilayer ceramic capacitor according to claim 1, wherein the base electrode layer further includes at least one conductive component selected from the group consisting of copper, nickel, and a copper-nickel alloy.

7. The multilayer ceramic capacitor according to claim 1, wherein in the thickness direction of the base electrode layer, when the mass ratio of the alkaline-earth metal in the glass present in the central portion is 100, a ratio of the alkaline-earth metal in the glass present in a near-surface portion adjacent to the multilayer body is 105 or more and 115 or less.

8. The multilayer ceramic capacitor according to claim 1, wherein
the base electrode layer is a sintered body layer of a conductive paste including a glass composition;
the glass composition includes Li₂O, Na₂O, Cao, Bao, and B₂O₃, and a mass ratio of a total of Li₂O, Na₂O, Cao, and Bao to B₂O₃ in the glass composition is 1.17 to 2.61.

9. The multilayer ceramic capacitor according to claim 1, wherein the alkaline-earth metal includes at least one of calcium, strontium, or barium.

10. The multilayer ceramic capacitor according to claim 9, wherein the alkaline-earth metal further includes magnesium.

11. The multilayer ceramic capacitor according to claim 4, wherein the alkali metal includes at least one of lithium, sodium, or potassium.

12. The multilayer ceramic capacitor according to claim 1, wherein the glass further includes zinc oxide, aluminum oxide, or bismuth oxide.

13. The multilayer ceramic capacitor according to claim 1, wherein a thickness of the base electrode layer is 10 μm or more and 50 μm or less.

14. The multilayer ceramic capacitor according to claim 1, wherein a thickness of the base electrode layer is 15 μm or more and 40 μm or less.

15. The multilayer ceramic capacitor according to claim 1, wherein the plating layer incudes nickel, copper, silver, gold, or tin, or an alloy of nickel, copper, silver, gold, or tin.

16. The multilayer ceramic capacitor according to claim 1, wherein the plating layer includes a plurality of layers including different materials.

17. The multilayer ceramic capacitor according to claim 1, wherein the plating layer includes a Ni plating layer and a Sn plating layer.

18. The multilayer ceramic capacitor according to claim 1, wherein the plating layer includes an upper plating layer and a lower plating layer each with a thickness of 0.5 μm or more and 10 μm or less.

19. The multilayer ceramic capacitor according to claim 1, wherein the multilayer ceramic capacitor has a dimension in a length direction of 2.0 mm or less, a dimension in a width direction of 1.25 mm or less, and a dimension in a stacking direction of 1.25 mm or less.
